(19) United States
(12) Patent Application Publication
(10) Pub. No.: US 2020/0356920 A1
(43) Pub. Date: Nov. 12, 2020

(54) RISK REDUCTION SYSTEM AND METHOD

(71) Applicant: GENERAL ELECTRIC COMPANY, Schenectady, NY (US)

(72) Inventors: Sameer VITTAL, Atlanta, GA (US); Mayoran RAJENDRA, Minato-ku (JP); Hiroaki SHIOI, San Ramon, CA (US); Kazuyuki ANCHI, Chiyoda-ku (JP); Keigetsu TAKAHASHI, Chiyoda-ku (JP); Yuma OCHI, Chiyoda-ku (JP)

(21) Appl. No.: 16/869,486

(22) Filed: May 7, 2020

Related U.S. Application Data
(60) Provisional application No. 62/844,223, filed on May 7, 2019.

(51) Int. Cl. G06Q 10/06; G06Q 50/04; G06Q 30/06; G06Q 10/08

(52) U.S. Cl. CPC G06Q 10/0635; G06Q 50/04; G06Q 30/0635; H04L 67/10; G06Q 10/06393; G06Q 10/087; G06Q 10/06375

(57) ABSTRACT

Provided are systems and methods for evaluating risks associated with a manufacturing process including a network interface configured to receive a request to evaluate a purchase order associated with a deliverable that includes one or more components for manufacture, a processor configured to evaluate a set of metrics associated with the deliverable to identify a status of each of the set of metrics, and an output configured to generate a risk evaluation representing a risk of delivery of the deliverable.

### CROSS-REFERENCE TO RELATED APPLICATIONS

The present application claims the benefit of and priority under 35 USC § 119(e) of U.S. Provisional Patent Application No. 62/844,223 filed on May 7, 2019, the entire contents of which are hereby incorporated by reference for all purposes.

### BACKGROUND

Manufacturing processes are complex and may involve a number of participants and process steps. For example, a typical manufacturing process involves participation of one or more suppliers of raw goods, materials or components. Those goods, materials and components are used to assemble or otherwise produce end products which then require sales operations to market, sell and deliver the final products to end customers. Problems or delays with any of the participants or steps in the process can have a negative impact on the ability to deliver quality finished products to customers.

It would be desirable to allow entities, such as financial institutions, to accurately evaluate the risk of delivery of final products using metrics associated with different participants and steps of the manufacturing process.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings, in which:

FIG. 1 is a diagram illustrating a system for risk evaluation of a manufacturing process in accordance with an example embodiment.

FIG. 2 is a diagram illustrating a lifecycle of a purchase order transaction.

FIG. 3 is a diagram illustrating a method for evaluating risks associated with a manufacturing process in accordance with an example embodiment.

FIG. 4 is a diagram illustrating a risk evaluation device for evaluating risks associated with a manufacturing process in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

The example embodiments are directed to a risk assessment system which may be used to evaluate a risk of non-delivery or late delivery of a deliverable (such as, for example, an item of manufacture). In some specific embodiments, the risk assessment system may be used to implement a cash conversion cycle (“CCC”) reduction process in which a manufacturer of a deliverable wishes to reduce the amount of time it takes to convert the deliverable to cash. The risk assessment system may be used by a financial institution, for example, to evaluate whether to enter into an agreement purchase the deliverable from the manufacturer for a fee, hold the deliverable for a period of time, and then sell the deliverable back to the manufacturer per the agreement. In this manner, the financial institution may deploy its capital more efficiently while providing short-term working capital to the manufacturer. Pursuant to some embodiments, the risk assessment system is required to accurately provide an indication of whether the manufacturing process is operating normally and that the deliverable will be delivered on time.

For convenience and ease of exposition, a number of terms are used herein. The term “deliverable” is used herein to refer to an item, system or component of manufacture that is manufactured for sale to end purchasers or “customers”. The term “manufacturer” is used to refer to an entity that is responsible for production of the “deliverable.” The manufacturer may assemble the deliverable from a number of source materials or components procured from one or more “suppliers”. The manufacturer may sell the deliverable to a customer using a “purchase order”.

Each of the steps and participants in the manufacturing process that result in a customer taking delivery of a deliverable include one or more metrics that may be monitored and tracked using, for example, operations software, monitoring devices, or the like. Pursuant to some embodiments, a risk assessment system monitors key performance indicators or metrics associated with each step and participant in the manufacturing process to identify any anomalies that may indicate a risk of delivery (such as a risk of non-delivery or late delivery) of the deliverable.

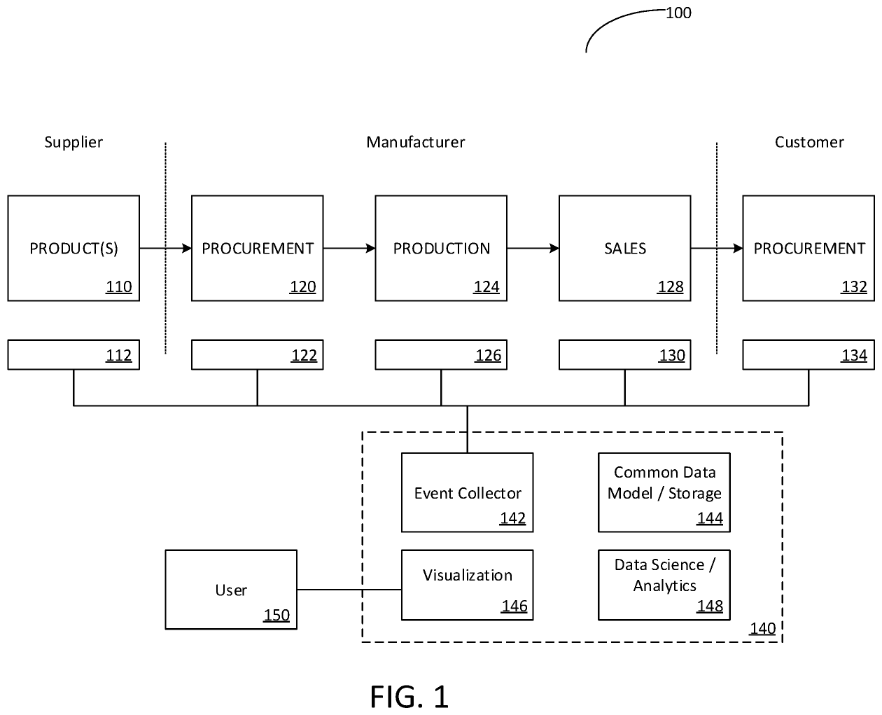

FIG. 1 illustrates a system 100 for performing risk assessments in a manufacturing environment in accordance with an example embodiment. Referring to FIG. 1, the system 100 includes a risk assessment platform 140 which may receive events and other data from one or more participants 110-132 in the manufacturing environment (e.g., via event collector 142) and store the data in a data storage subsystem 144 for analysis by data science tools and analytics subsystem 148. The results of any risk assessments may be presented to a user operating a user device 150 via a visualization subsystem 146. The participants in the manufacturing environment may include one or more suppliers of one or more products 110 (such as components or raw materials), a manufacturer (which includes manufacturer participants or events relating to procurement 120, production 124 and sales 128 activities) and one or more customers procuring 132 deliverables from the manufacturer. Each of the activities or processes performed by the suppliers, manufacturer and customers may be associated with metrics or performance indicators. Pursuant to some embodiments, one or more event emitters or edge devices 112, 122, 126, 130 and 134 may be operated to transmit event data associated with the activities of the supplier, manufacturer and customer. In some embodiments, the some or all of the devices 112, 122, 126, 130 and 134 may be Internet-connected devices capable of collecting and transmitting metrics and other data to an event collector 142 of risk assessment platform 140 for further analysis as described herein.

A wide variety of metrics or data may be collected. For example, data associated with a supplier may include metrics such as: Percent of Perfect Orders, Procurement Quality, Transportation Quality, Warehousing Quality, Customer Order Cycle Time below target, Fill Rate, Inventory Days of Supply, Freight Bill Accuracy, On-Time Shipping Rate, Inventory Turnover, Turn-Earn Index, Gross Margin Return on Investment, Days of Supply, Inventory Velocity, etc. Data associated with these metrics may be aggregated or computed from various sources (such as, for example, an expected order delivery date may be taken from a purchase order, while the actual order delivery date may be taken from lading or shipping manifest data).

A variety of manufacturing metrics may also be collected. For example, metrics associated with the manufacturer may include: Overall Equipment Effectiveness, Reliability, Availability, Maintainability ($/Machine-Hr.), Throughput yield, Part Quality, Spares Availability, Planned Downtime (Hr.), Unplanned Downtime (Hr.), Operations and Maintenance Costs ($/Hr.), etc. Again, data associated with these metrics may be aggregated or computed from various sources.

A variety of financial metrics may also be collected or computed. For example, financial metrics may include: Credit Rating, Interest Rates, Consumer Price Index, Cancellation ratio of PO/AR, the average lead time from PO to AR, AR to Deposit, Manufacturing, etc. These financial metrics may be determined for different participants in the manufacturing process. For example, the credit rating of a supplier may be collected as well as the credit rating of the manufacturer. Each of these metrics may be transmitted to the risk assessment platform 140 and collected by event collector 142 for storage in a common data storage model in a database 144.

The risk assessment platform 140, the control system 120, the edge or metric devices 112, 122, 126, 130 and 134, and the user device 150 of the system 100 may be connected to each other through a wired connection and/or through a network connection such as a public network (e.g., the Internet) or a private network. In some examples, one or more of the risk assessment platform 140, the edge devices 112-134, and the user device 150 may be incorporated together with one another on the same device or system. Although not shown in FIG. 1, it should be appreciated that the system 100 may include other devices, components, and even systems not shown.

The edge devices 112-134 may be in communication with one or more business systems at their respective (supplier, manufacturer, and customer) environments and may include integrations with one or more business systems such as enterprise resource planning (“ERP”), product lifecycle management (“PLM”), laboratory information management systems (“LIMS”), enterprise asset management (“EAM”), customer relationship management (“CRM”), human resource management (“HRM”), and the like. The edge devices 112-134 may also include integrations with one or more control systems such as programmable logic controllers (“PLC”), distributed control systems (“DCS”), supervisory control and data acquisition (“SCADA”), and hardware devices (e.g., printers, scanners, copiers, networked devices, workstations, and the like). In general, the edge devices 112-134 are configured to obtain data representative or usable to determine one or more KPIs for use in assessing risk as described herein. The devices may be included at the supplier, manufacturing or customer site, in the cloud, at another remote location, or a combination thereof. The edge devices 112-134 may also include computing devices, sensors, workstations, and the like, for monitoring the components of the manufacturing site (work centers, workstations, production line, assembly line, etc.) and sending information to the risk assessment platform 140 where it may be further analyzed.

According to various embodiments, the risk assessment platform 140 may provide a user interface which provides information to a user (e.g., such as a user operating a user device 150) about a purchase order to be analyzed as well as the analysis results.

Pursuant to some embodiments, a common data model is used to store information about purchase orders and for storage 144. For example, a common data model may describe data elements associated with a supplier purchase order (including a supplier code, description, order number, equipment code, equipment description, equipment quantity, equipment unit of measurement, promised delivery date, order creation date, order status, order shipping tracking number, and receipt date). A common data model may describe data elements associated with the customer purchase order as well (and may have similar elements as the supplier purchase order). The model may also describe data elements associated with a manufacturer work order (including an order number, quantity, planned start date, planned end date, actual start date, actual end date, creation date, status, order number, and order item number) and a production tracker (including a production event number, event status, work order number, event number, master operation code, operation start time, end time, status and location). Each of these data elements may be tracked and populated for each purchase order using data from data collectors such as edge devices 112-134 and used in performing risk analyses as described herein.

Pursuant to some embodiments, data science/analytics operations may be performed using data science/analytics modules 148 to generate models that are predictive of risk as described herein. A number of machine learning and predictive analytic techniques may be used to generate a model that is predictive of risk. As an example, a stacked ensemble (a combination of Gradient Boosting, Random Forests and Deep Learning) has been found to have an almost perfect validation score and an AuC of 99.999% and providing desirable results, however, it is expected that a number of approaches will provide desirable results.

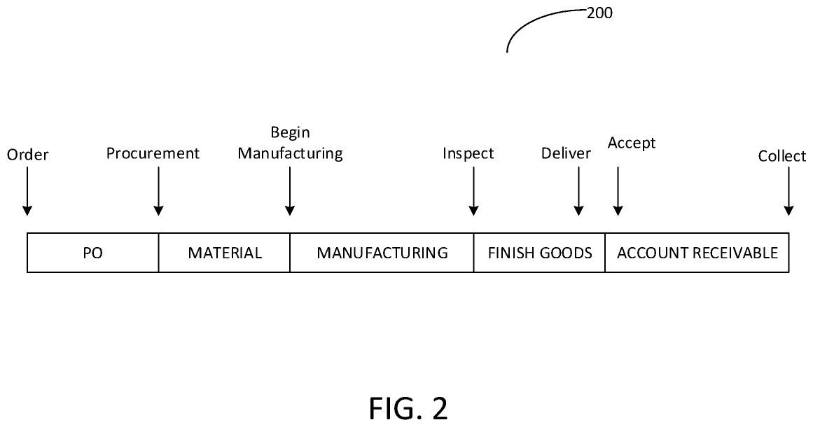

FIG. 2 illustrates a typical manufacturing sequence 200 from the time a purchase order is issued for a deliverable to the time the deliverable is delivered and accepted and the manufacturer is paid. The sequence 200 is shown to illustrate that the period of time between when a purchase order is issued and when the manufacturer is actually paid can be a significant amount of time. A financial metric used to measure this sequence is the “cash conversion cycle” or “CCC” which expresses the time (in days) it takes for a manufacturer (or other entity) to convert its investment in inventory and other resources into cash flows from sales. The CCC metric attempts to measure how long each net input dollar is tied up in the production and sales process before it gets converted into cash received. The CCC metric takes into account how much time the manufacturer (or other entity) needs to sell its inventory, how much time it takes to collect receivables, and how much time it has to pay its bills without incurring penalties. In general, a trend of decreasing (or steady) CCC values over multiple periods is a sign of a company's good health, while rising CCC values may indicate a problem.

In general, the CCC is calculated as the “Inventory Conversion Period” plus the “Receivables Collection Period” minus the “Payables Deferral Period”. The “Inventory Conversion Period” is the Inventory value divided by the sales per day. The Receivables Collection Period is the value of the Receivables divided by the total sales times 365 days. The Payables Deferral Period is the value of the Payables divided by the Cost of Goods Sold multiplied by 365 days.

The CCC is also referred to as the “net operating cycle”. This cycle tells a business owner the average number of days it takes to purchase inventory, and then convert it to cash. That is, it measures the time it takes a business to purchase supplies, turn them into a product or service, sell them, and collect accounts receivable (if needed). The CCC time is dependent upon how a company finances its purchases, how it allows customers to pay (credit and the collection period), and how long it takes to collect. A lower CCC is an indicator of a faster inventory-to-sales process. A higher CCC indicates a slower process. A low CCC is generally accepted as more desirable, although this depends on your business, industry, and capabilities. Previously, to calculate CCC, a business referred to its financial statements such as the balance sheet and income statement to obtain the information for the calculations.

Pursuant to some embodiments, the system 100 of FIG. 1 can be operated to allow a manufacturer's CCC to be reduced. More particularly, embodiments effectively reduce the time, for example in days, that a manufacturer (or other entity) uses to convert purchase order/finished goods/inventory into cash at an earlier stage based on the metrics collected and analyzed by the system 100. Pursuant to some embodiments, by connecting these data sources and measuring certain metrics or key performance indicators (KPIs), it can be evaluated whether an entity (such as a financial institution) should purchase purchase orders (POs) from the manufacturer for a fee, and then financially hold those PO's for a predetermined period of time, and then sell the POs back to the manufacturer when the POs are converted to account receivables. Pursuant to some embodiments, this allows capital to be redeployed more efficiently while providing short-term working capital to the manufacturer, who further benefits from increased liquidity via the CCC reduction.

Because the financial institution will assume a risk of holding the deliverable during a waiting period (the period of time between when the financial institution purchases the PO and the time when it can be sold back to the manufacturer), embodiments provide risk analysis methods to provide the financial institution with insight into the manufacturer and supply chain operations and allow the generation of a risk score to guide the financial institution's decision whether to accept the risk in a given transaction. The risks that arise during the waiting period can arise from a number of events such as products not being sold due to delays in production, quality issues, obsolescence, cancelled orders due to issues at the customer end, trade issues, or the like. Embodiments utilize edge devices and other metric collectors to track critical manufacturing, supply chain and financial metrics for every sales transaction. Using historical data, these transactions can be classified as “normal” (e.g., the full payment was received on time without any issues), or “anomalous”. By using predictive analytics on these datasets, a set of risk scoring algorithms can be developed to (a) alert the financial institution when KPI's are trending in the wrong direction, and (b) predict the probability of an individual transaction being anomalous, so the appropriate financial controls can be applied.

Pursuant to some embodiments, methods are provided to allow an entity (such as a financial institution) to buy purchase orders to convert purchase orders into cash taking account for the performance of a manufacturer on a real-time basis at a more granular level (e.g., such as at the product or customer level). Previously, assessment of a manufacturer's performance required review of quarterly financial statements. Embodiments allow near-real time evaluation of metrics allowing CCC reduction as described herein.

CCC reduction is critical as it evaluates the efficiency and health condition of a company's management and financial flow since CCC is a metric that shows the time, for example, in days that a company uses to convert finished goods/inventory into cash. In other words, CCC measures how fast a company can convert cash to materials and parts needed for manufacturing, materials, and parts to inventory, inventory to sales and accounts receivable, and accounts receivables back into cash.

Reduction of CCC pursuant to the present invention has a direct impact on shortening CCC since the lead time from purchase order to sales is shortened in the calculation of CCC once the POs are converted into cash. Therefore, the manufacturer can redeploy the cash to drive more effective manufacturing.

Referring again to FIG. 2, embodiments effectively allow a PO to be converted to cash at the time of an order (rather than waiting until after the goods are finished and the order delivered and accepted by the customer). Embodiments allow such a conversion based on a risk calculation of the probability that the PO will convert from a PO to accounts receivable. For example, as discussed above, the platform 100 can be operated to perform a risk assessment identifying a delivery risk (or other manufacturing risk). Embodiments can be used to perform risk assessments associated with each of the phases shown in FIG. 2 (including, for example assessment of risks that result in delays or unavailability of material in the procurement phase, or delays or other issues in the manufacturing phase, etc.). If the risk of delays or other issues is low, an entity such as a financial institution may purchase a PO as described herein. In some embodiments, a transaction fee may be assessed for such a purchase. The risk assessed may be constructed as the risk that the PO may be canceled (e.g., by an end customer such as for a delay, for nonconforming products, or the like). If the metrics associated with a manufacturer and similar POs indicates that over 90% of such POs are not canceled, then the risk of PO default may be considered low. Further, pursuant to some embodiments, given a volume of POs and a confidence in the risk assessment, the fixed amount of a PO may be converted into a revolving credit.

In some embodiments, the platform 100 may be operated to calculate an amount that a manufacturer can receive from a financial services provider pursuant to the present invention. For example, the amount that can be received (c) can be calculated as (c)=(a)*M %+(b), where (a) is the total amount of the PO (in a particular month), (b) is a base amount set by the financial services provider for that customer, and M is the risk confidence level calculated by the platform 100 for the PO (based on historical data and analytics as described herein). In some embodiments, a financial services provider may use the risk assessment techniques described herein to extend a base amount (b) to a manufacturer, where the base amount (b) is selected based on a volume or pace of POs or other metrics. The base amount (b) is effectively an amount of revolving credit provided by the financial services provider to the manufacturer. Each month (or on some other regular basis), the financial services provider may perform the calculation to identify the amount (c) as shown above, and then may determine the amount the manufacturer already received the prior period (d) and pay the difference between (c) and (d). In this manner, the financial services provider makes lending decisions based on substantially real-time risk assessments and provides improved cash flow to the manufacturer.

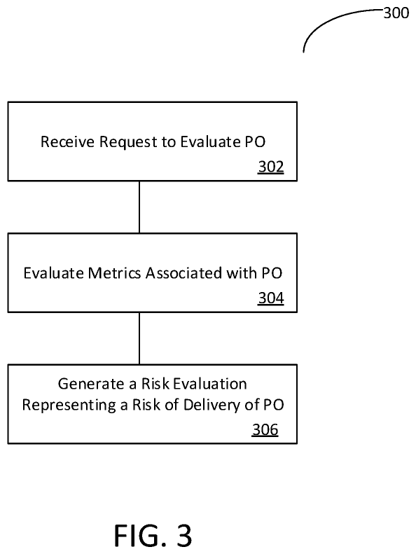

FIG. 3 illustrates a method 300 for analyzing a risk associated with a purchase order in accordance with an example embodiment. For example, the method 300 may be performed by the risk assessment platform 140 shown in FIG. 1, or it may be performed by another device. Referring to FIG. 3, in 302 the method includes receiving a request to evaluate a risk associated with a purchase order that includes one or more components for manufacture. For example, the purchase order may be an order to procure a deliverable from a manufacturer. The purchase order may identify the manufacturer, the price, delivery terms and product information. The request at 302 may be received from a user operating a user device 150 or from some other device in communication with the risk assessment platform 140. In some embodiments, the request may be for an analysis of a number of purchase orders associated with a manufacturer.

Processing continues at 304 where the method includes evaluating one or more metrics associated with the purchase order. The metrics may be metrics that have previously been collected (e.g., using the edge devices and event collectors 142 of FIG. 1) or may be a set of metrics that require collection (e.g., such as in a situation where the purchase order relates to a deliverable that has not previously had data collected or modeled pursuant to the present invention).

Processing continues at 306 where the system causes the generation of a risk evaluation representing a risk of delivery of the purchase order. For example, the risk evaluation may be expressed as a confidence level that the deliverable of the purchase order will be delivered on time and in a manner that will pass a customer's acceptance criteria. The risk evaluation generated at 306 may be generated using one or more models created pursuant to the present invention. For example, the models may be designed to identify transactions or events that are normal as well as those that appear to be anomalous. In some embodiments, the result of the risk evaluation may be a transaction as described herein to perform a cash conversion cycle reduction by PO purchase.

In some embodiments, the method 300 may also include processing to facilitate the purchase of a PO to reduce a cash conversion cycle. For example, terms and conditions of an offer to purchase may be presented to a user operating a user device 150. The terms may include a purchase price calculated as described above (e.g., where the PO amount is multiplied by the risk confidence level less a transaction fee).

In some embodiments, displays may be provided that include information about a manufacturer's account receivable condition to allow a user to selectively analyze PO's for potential use in reducing a cash conversion cycle. For example, a dashboard may be created that allows a user to visualize the amount of current accounts receivable (“AR”) as well as future AR over time. A user may use such a display to identify which AR could be the most suitable candidate for application of the CCC conversion process. Users may then selectively choose certain POs or groups of POs for conversion. Data for such a display may include information about the entity and its customers, as well as information about the POs (including the PO identifier, the date of the PO, the accounts receivable date, the currency and PO amount as well as information associated with the risk confidence level calculated pursuant to the present invention).

Other dashboards may be provided to present data associated with risk. For example, a dashboard may be presented with information to visualize the cancel ratio of POs in the past based on the entity as well as its customers. Other dashboards or displays may be provided that allow a user to view one or more POs and cause them to be automatically converted to purchase or sale agreements for submission to a financial services provider. Those skilled in the art, upon reading this disclosure, will appreciate that a wide variety of reports and displays may be provided, as embodiments provide a large number of data points about purchase orders and manufacturing processes that were not previously available to users.

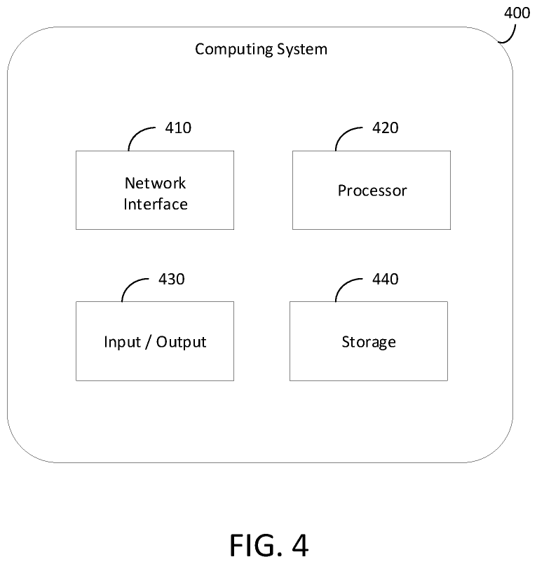

FIG. 4 illustrates a risk assessment device 400 for evaluating risk associated with a manufacturing process in accordance with an example embodiment. For example, the risk assessment device 400 may correspond to risk assessment platform 140 shown in FIG. 1, or another device, and may be capable of performing the method 300 shown and described with respect to FIG. 3. The risk assessment device 400 includes a network interface 410, a processor 420, an output 430, and a storage 440. The network interface 410 may transmit and receive data to and from other devices through a network such as the Internet, a private network, public network, and the like. The processor 420 may include one or more processing devices each having one or more processing cores. The processor 420 may control the overall operations of the risk assessment device 400. The output 430 may output a user interface to a display device such as a display device of the risk assessment device 400 or a display device of an externally connected device or cloud connected device (such as, for example, the user device 150 of FIG. 1). The storage 440 may store information about data received from a supplier, a manufacturer and/or a customer (such as metric data associated with the status of an item of manufacture or other metrics described herein).

In this example, the network interface 410 may receive metric or event data from edge devices 112, 122, 126, 130, 134 as well as a request for a risk assessment associated with a PO received from a user device 150. The processor 420 may cause metric data to be stored in a storage device 144, cause one or more data science or analytics operations to be executed or provide a visualization or other output to a user operating a user device 150. The output 430 may display a risk assessment of a purchase order including an assessment of whether a CCC operation may be executed as described herein.

In some examples, a risk assessment corresponding to the request received by the network interface 410 may include information identifying a specific purchase order as well as the manufacturer and deliverable associated with the purchase order. In this example, the processor 420 may determine a manufacturing progress of each respective component of the purchase order and generate a risk assessment of the risk of delivery of the deliverable. In some examples, the processor 420 may determine a risk assessment of a plurality of purchase orders associated with a plurality of manufacturers and deliverables.

According to various example embodiments, described herein is a system and method for managing work in process for manufacturing. The examples herein provide a user interface that provides a user with real-time information about a risk of delivery of deliverables associated with purchase orders. In some embodiments, the risk may be used to predict information about a cash conversion cycle and make a determination whether to buy the purchase order.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A risk evaluation device for evaluating risks associated with a manufacturing process, the device comprising:
a network interface configured to receive a request to evaluate a purchase order associated with a deliverable that includes one or more components for manufacture;
a processor configured to evaluate a set of metrics associated with the deliverable to identify a status of each of the set of metrics; and
an output configured to generate a risk confidence level representing a risk of delivery of the deliverable.

2. The risk evaluation device of claim 1, wherein the purchase order comprises a plurality of data elements, and the processor is further configured to determine a current status of each of the plurality of data elements and perform a predictive analysis of an outcome based on the current status.

3. The risk evaluation device of claim 1, wherein the status of each of the plurality of data elements is based on information received from a plurality of edge devices each associated with at least one of a supplier system and a manufacturer system.

4. The risk evaluation device of claim 1, wherein the status of at least one of the plurality of data elements is based on information received from financial market reports associated with at least one of a supplier and a manufacturer.

5. The risk evaluation device of claim 1, wherein the processor is further configured to predict a reduced cash conversion cycle based on the risk evaluation.

6. The risk evaluation device of claim 1, further comprising:
generating an offer to buy the purchase order based on the risk confidence level, the offer including a price calculated by multiplying the risk confidence level by the purchase order value.

7. A system for cash conversion cycle reduction comprising:
a processor; and
a non-transitory computer-readable medium comprising instructions that, when executed by the processor, perform a method, the method comprising:
receiving an indication of a receipt of a purchase order for manufacture of a product by an entity;
receiving one or more key performance indicators associated with the manufacture of the product by the entity;
predicting a reduced cash conversion cycle based upon the one or more key performance indicators; and
displaying information associated with the reduced cash conversion cycle.

8. The system of claim 7, further comprising instructions that perform a method comprising:
receiving a request to buy the purchase order based upon the predicted cash conversion cycle; and
sending a financial offer to the entity to buy the purchase order.

9. The system of claim 7, wherein the one or more key performance indicators includes financial data, manufacturing data, and inventory data associated with the manufacture of the product by the entity.

10. The system of claim 8, wherein the financial offer is an amount approximately equal to the risk confidence level multiplied by the amount of the purchase order.
